(19) United States
(12) Patent Application Publication
(10) Pub. No.: US 2023/0098235 A1
(43) Pub. Date: Mar. 30, 2023

(54) WEARABLE ADVERTISEMENT DEVICE HOLDER

(71) Applicant: Ronald Anguiano, San Antonio, TX (US)

(72) Inventor: Ronald Anguiano, San Antonio, TX (US)

(21) Appl. No.: 17/490,928

(22) Filed: Sep. 30, 2021

(51) Int. Cl. G09F 21/02; A45F 3/14

(52) U.S. Cl. CPC G09F 21/026; A45F 3/14; A45F 2200/0525; A45F 2003/142

(57) ABSTRACT

Disclosed are systems and methods for a wearable advertisement device holder. Particularly, the disclosure may relate to a wearable element that may be configured to hold one or more mobile devices, such as a tablet, smartphone, computer, or the like, such that a user may be able to display digital advertisements from their person.

### BACKGROUND

Devices used to present advertisements to users exist in any number of different forms. As a first example, in some cases, displays may be affixed to a portion of a vehicle and may present digital or printed advertisements. As a second example, advertisers may purchase printed or digital roadside billboard space. However, the capability for an individual user to display advertisements (for example, while walking in public) is limited, or inconvenient.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 illustrates an example embodiment of a wearable element, in accordance with one or more embodiments of the disclosure.

FIGS. 2A-2B illustrate additional example embodiments of wearable elements, in accordance with one or more embodiments of the disclosure.

FIG. 3 illustrates another example embodiment of a wearable element, in accordance with one or more embodiments of the disclosure.

FIG. 4 illustrates another example embodiment of a wearable element, in accordance with one or more embodiments of the disclosure.

FIG. 5 illustrates another example embodiment of a wearable element, in accordance with one or more embodiments of the disclosure.

FIG. 6 illustrates another example embodiment of a wearable element, in accordance with one or more embodiments of this disclosure.

### DETAILED DESCRIPTION

This disclosure relates to, among other things, a wearable advertisement device holder (which may be referred to as a “wearable element” herein). Particularly, the disclosure may relate to a wearable element that may be configured to hold one or more mobile devices, such as a tablet, smartphone, computer, or the like, such that a user may be able to display digital advertisements from their person. For example, the user may wear the wearable element and may walk within an environment while wearing the wearable element such that advertisements may be displayed to other individuals in the environment through the mobile device as the user walks. The wearable element may be an enclosure comprised of a flexible material, such as a fabric, plastic, or any other type of material that may be suitable for a user to wear. The wearable element may include one or more straps that may allow a user to wear the wearable element around their shoulders. The wearable element may also be weather resistant to protect the device held within the wearable element. The wearable element may also include multiple separated compartments for storing any additional items that may be useful, such as an external battery for the device. Additionally, the wearable element may be configured such that a user may be able to access the various compartments within the wearable element in different manners, allowing for ease of access and item storage and/or removal. Additional configuration details for different embodiments of this wearable element may be described below in association with the figures.

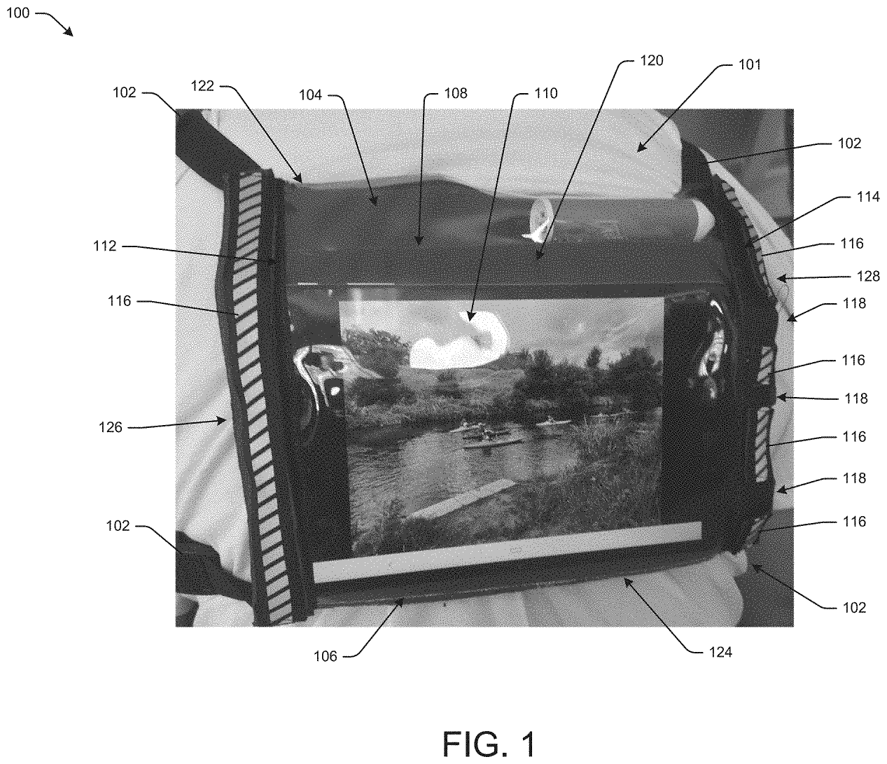

Turning to the figures, FIG. 1 illustrates an example wearable element 100, in accordance with one or more embodiments of the disclosure. The wearable element 100 may represent a first example embodiment of such a wearable element. The wearable element 100 may include one or more straps 102 that may be used to secure the wearable element 100 to a user 101. That is, the user 101 may place the straps 102 around their shoulders such that the wearable element 102 may be secured to a torso of the user 101. In this manner, the user 101 may be able to carry a mobile device 110 used to present advertisements within the wearable element 100, and may be able to walk within an environment and display advertisements through the mobile device 110 in a hands-free manner. The straps may be made of elastic material to allow the straps to easily and comfortably conform to the shoulders of the user 101. However, the straps may also be made of any other material as well. Additionally, while the figure may depict two straps 102 being affixed to either side of the wearable element 102, any other number of straps 102 may similarly be used. The straps 102 may also be affixed to the wearable element 102 at variety of different locations. In some cases, the straps 102 may be permanently affixed to the wearable element 102. However, in some cases, the straps 102 may be removably affixed to the wearable element 102. For example, the straps 102 may be removably affixed to the wearable element 102 using hook-and-loop fastener material, or may be removably affixed in any other suitable manner. The straps 102 may also be configured to secure the wearable element 102 to the user 101 in any other manner other than around the shoulders of the user 101 as well. For example, the straps 102 may extend around the torso of the user 101.

The wearable element 100 may also include one or more compartments (for example, a first compartment 104, a second compartment 106, and/or any other number of compartments) for receiving and holding various types of items. For example, the second compartment 106 illustrated in the figure may be configured to receive a mobile device 110 that is capable of displaying digital advertisements. The mobile device 110 may be, for example, a tablet, smart phone, computer, or any other similar type of device. The first compartment 104 illustrated in the figure may be configured to receive other items, such as accessories to the mobile device 110 (for example, an external battery that may be used to provide additional battery life for the mobile device 110 to provide the mobile device 110 a longer amount of time to display advertisements).

The wearable element 100 may include a back portion (not shown in the figure) and a front portion 120. The front portion 120 may include any fully or partially transparent material, such as plastic, or any other type of material. The front portion 120 may be fully or partially transparent to allow other users to view the display of the mobile device 110, so that these users may be able to view digital advertisements presented on the mobile device 110. The back portion may include any type of material and may not necessarily be limited to partially or fully transparent material. This may be because the back portion may be facing a backside of the user 101 when the user 101 is wearing the wearable element 100. The back portion and the front portion 120 may be affixed to one another such that the mobile device 110 (and any other items) may be partially or fully enclosed by the wearable element 100. For example, the front portion 120 and back portion may both include a top edge 122, a bottom edge 124, a left edge 126, and a right edge 128, and these edges may be connected (for example, sewn together, or connected in any other manner). However, the back portion and the front portion 120 may be connected together through sections other than the edges as well. With the back portion and front portion 120 being connected, the mobile device 110 (and any other items) may be secured within the wearable element 100, such that the mobile device 110 (and any other items) does not fall out of the wearable element 100 while the wearable element 100 is secured to the user 101. Additionally, the wearable element 100 being configured in this manner may allow for the mobile device 110 (and any other items) to be protected from weather, such as rain, wind, etc.

In some cases, the one or more compartments may be physically separated. For example, as illustrated in the figure, the first compartment 104 and the second compartment 106 may be separated by a seam 108. The one or more compartments may also be separated in any other suitable manner as well. Additionally, the one or more compartments may be physically accessible from any side. As depicted in the embodiment illustrated in FIG. 1, the one or more compartments may include openings on the left and right-hand sides of the wearable element 100. These openings may be accessible by a user by removing hook-and-loop fastener straps 112 from either side of the one or more compartments. These hook-and-loop fastener straps may also be used to seal the openings for the one or more compartments when access to the inside of the one or more compartments is no longer required. In some cases, reflective material 116 may also be affixed to the hook-and-loop fastener straps. The reflective material 116 may provide visibility to the user wearing the wearable element 100 in conditions where a second user may have difficulty seeing the user (for example, during nighttime).

Although reference may be made herein to the use of hook-and-loop fastener straps to provide access to the interior portion of the one or more compartments, any other suitable mechanisms may also be employed. For example, one or more zippers may be affixed to the one or more compartments rather than using the hook-and-loop fastener straps. Furthermore, the hook-and-loop fastener straps may include one or more gaps 118 at one or more locations along the hook-and-loop fastener straps. The one or more gaps 118 may provide portions of openings that may not be sealed by the hook-and-loop fastener straps. This may allow for smaller items from an exterior of the wearable element 100 to the interior of the one or more compartments. For example, a power cable may be routed from the first compartment 104 through a first gap associated with the first compartment 104, through a second gap associated with the second compartment 106, and into the interior of the second compartment 106. In this manner, a power cable from an external power supply located in the first compartment 104 may be routed to the device 110 in the second compartment 106. This is merely one non-limiting example of where such gaps 118 may be located, however. As a second example, gaps may be included in between the one or more compartments, such that items (for example, the power cable as mentioned above) may not need to be routed to the environment external to the wearable element 100 in order to be routed between the one or more compartments. That is, one or more gaps may be added between the seam 108 illustrated in the figure. As another example, the one or more gaps may be located at the front or the back of the wearable element 100 as well.

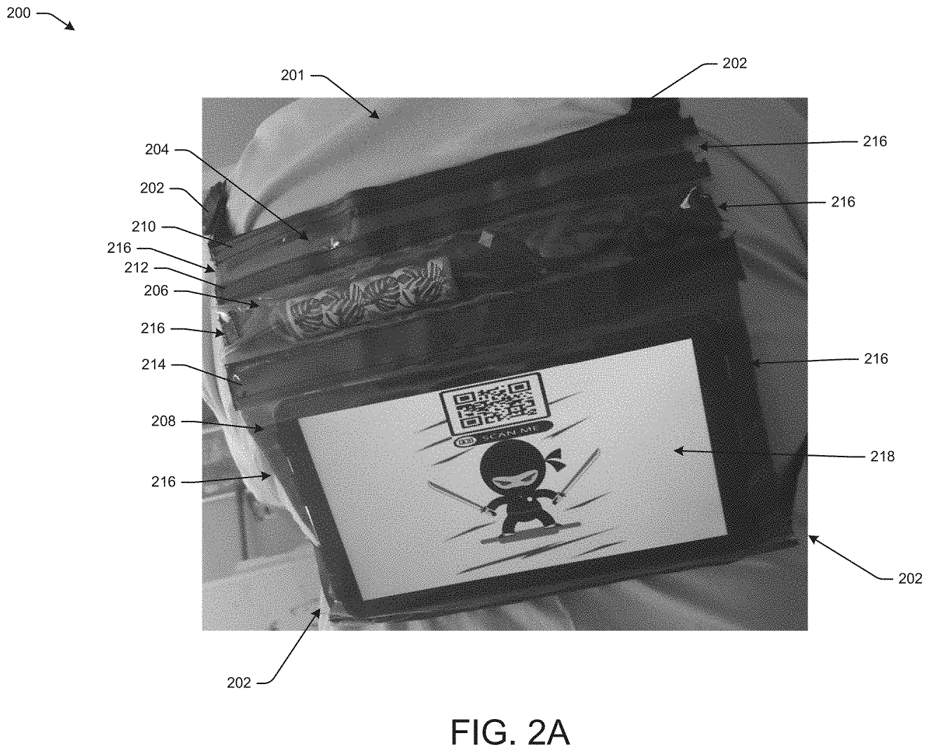

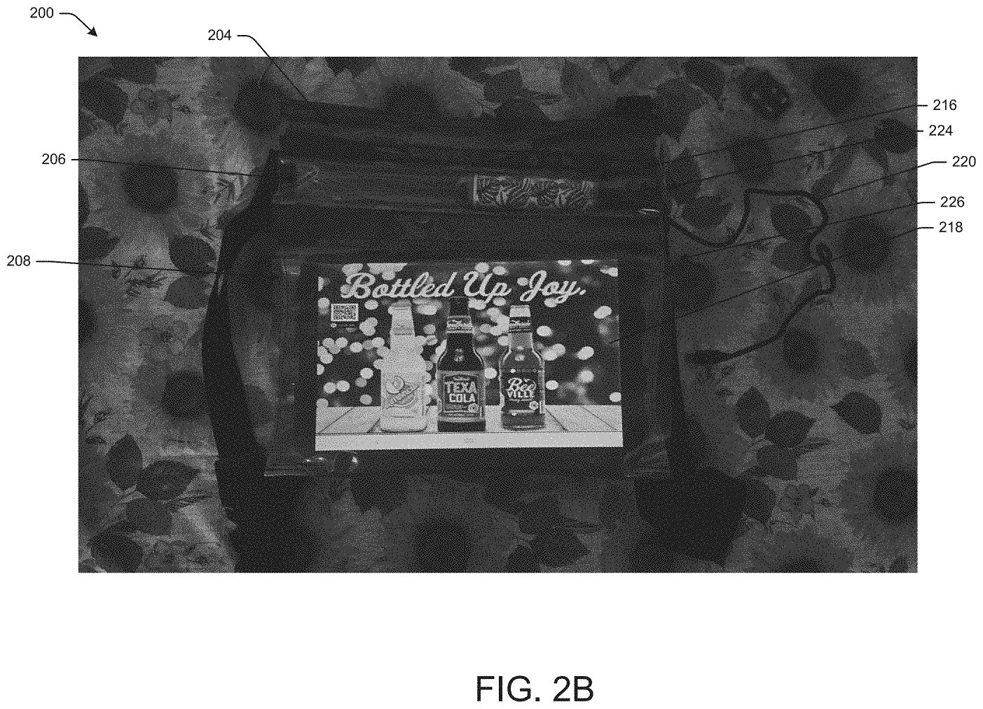

FIGS. 2A-2B illustrate an example wearable element 200, in accordance with one or more embodiments of the disclosure. The wearable element 200 may be another embodiment of a wearable element as described herein. As depicted in FIG. 2A, the wearable element 200 may include similar features as the wearable element 100. For example, the wearable element 200 may include one or more straps 202. The wearable element 200 may also include one or more compartments (for example, a first compartment 204, a second compartment 206, and/or a third compartment 208, as well as any other number of compartments). The wearable element 200 may also include one or more openings 216.

The wearable element 200 may, however, differ from the wearable element 200 in several ways. For example, the wearable element 200 may be illustrated as including three compartments (for example, a first compartment 204, a second compartment 206, and/or a third compartment 208, as well as any other number of compartments). For example, the third compartment 208 may be sized to be able to hold a mobile device 218, such as a tablet, smart phone, computer, or any other similar type of device (similar to the mobile device 110 of FIG. 1). The first compartment 204 and/or the second compartment 206 may be used to hold additional items that may be useful to the user 201, such as an external power supply for the mobile device 218, and/or any other type of item. The wearable element 200 including three compartments instead of two compartments (as illustrated with the wearable element 100) may not necessarily be limiting, but rather may illustrate that a wearable element as described herein may include any number of compartments (including less than or more than two or three compartments as well).

The wearable element 200 may also differ from the wearable element 100 in that the one or more openings 216 may not be sealable by hook-and-loop fastener straps (such as the hook-and-loop fastener straps illustrated in FIG. 1). In this manner, the one or more openings may be permanently open to allow for easier access to the interior of the one or more compartments. This will prevent any items held within the one or more compartments from falling outside of the wearable element 100 through the one or more openings 216, at least a portion of some or all of the interior of the one or more compartments may include hook-and-loop fastener material. In this manner, if hook-and-loop fastener is also included on a backside of any items added to the interior of any of the compartments, the items may be removably affixed to the hook-and-loop fastener included in the interior of the relevant compartment. The items may also be removably affixed to the interior of any of the compartments using any other type of material as well.

FIG. 2B depicts the same wearable element 200 as depicted in FIG. 2A. FIG. 2B may illustrate the use of the one or more openings 216. As illustrated in the figure, the second compartment 206 may include an external power supply including a cable 220. The third compartment 208 may include a mobile device 218. A first opening 224 associated with the second compartment 206 may allow for the cable 220 to be routed from the external power supply 216 in the second compartment 206, through a second opening 226 associated with the third compartment 208 to provide power from the external power supply 216 to the mobile device 218.

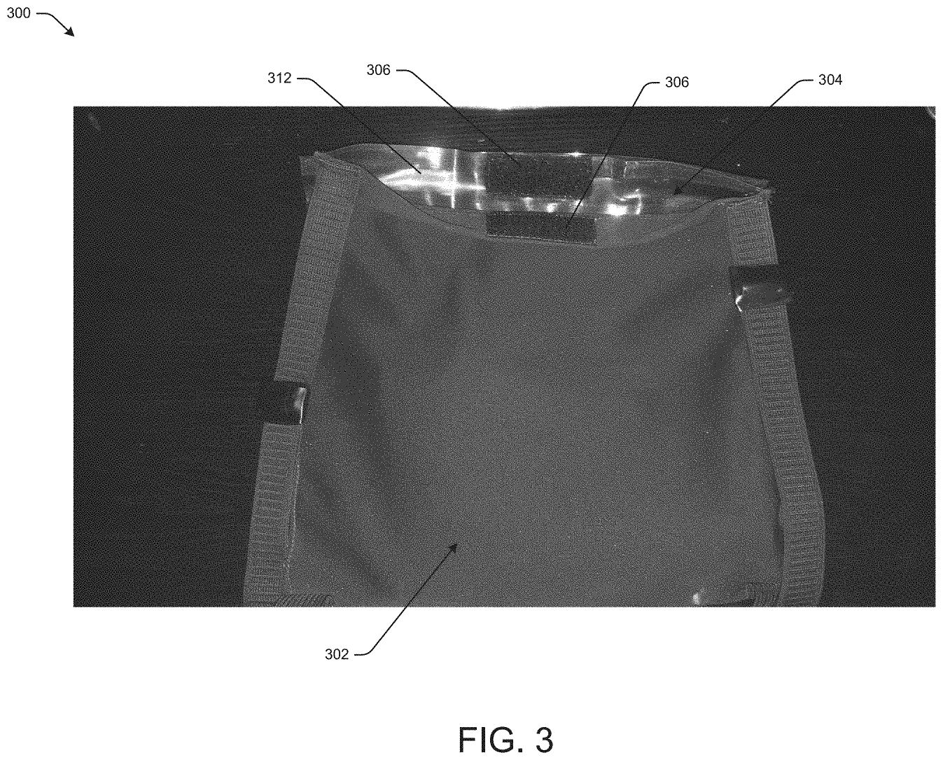

FIG. 3 depicts a back side 302 of a wearable element 300 as described herein. The wearable element 300 may be the same as any of the wearable elements described herein, such as wearable element 100, wearable element 200, wearable element 400, wearable element 500, and/or wearable element 600. That is, the wearable element 300 may include a front side 312 that, in some cases, may be made from a partially or fully transparent material, such as a plastic, or any other type of material. The wearable element 300 may also include a rear compartment 304. The rear compartment 304 may be an additional compartment located on the back side 302 of the wearable element 300 that that may be used to hold additional items. The rear compartment 304 of the wearable element 300 may be partially or completely sealable. For example, the wearable element 300 may include a hook-and-loop fastener 306. However, the rear compartment 304 may be sealable in any other manner as well (for example, using a zipper, etc.).

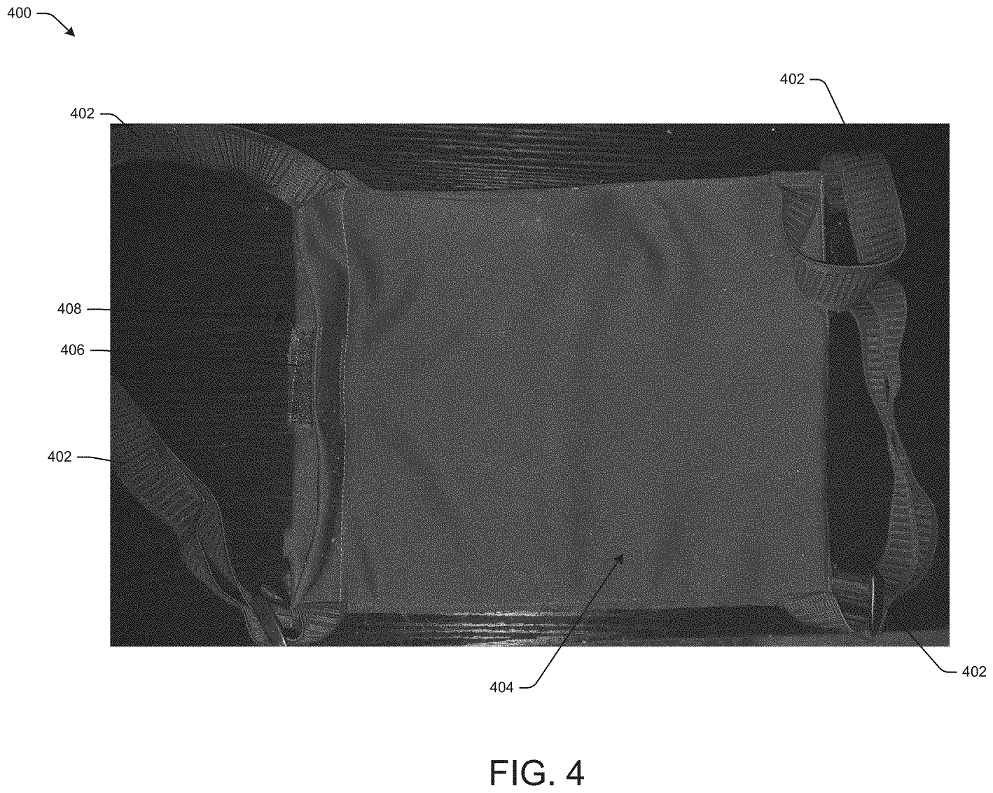

FIG. 4 depicts a back side of a wearable element 400 as described herein. The wearable element 300 may be the same as any of the wearable elements described herein, such as wearable element 100, wearable element 200, wearable element 400, wearable element 500, and/or wearable element 600. The wearable element 400 depicted in the figure may illustrate that the rear compartment may be accessible from any side of a wearable element. For example, as depicted in FIG. 4, the rear compartment may be accessible from an opening 408 on a side of the wearable element 400. Like the rear compartment depicted in association with the wearable element 300 of FIG. 3, the rear compartment of the wearable element 400 may be partially or completely sealable. For example, the wearable element 400 includes a hook-and-loop fastener 406. However, the rear compartment may be sealable in any other manner as well (for example, using a zipper, etc.).

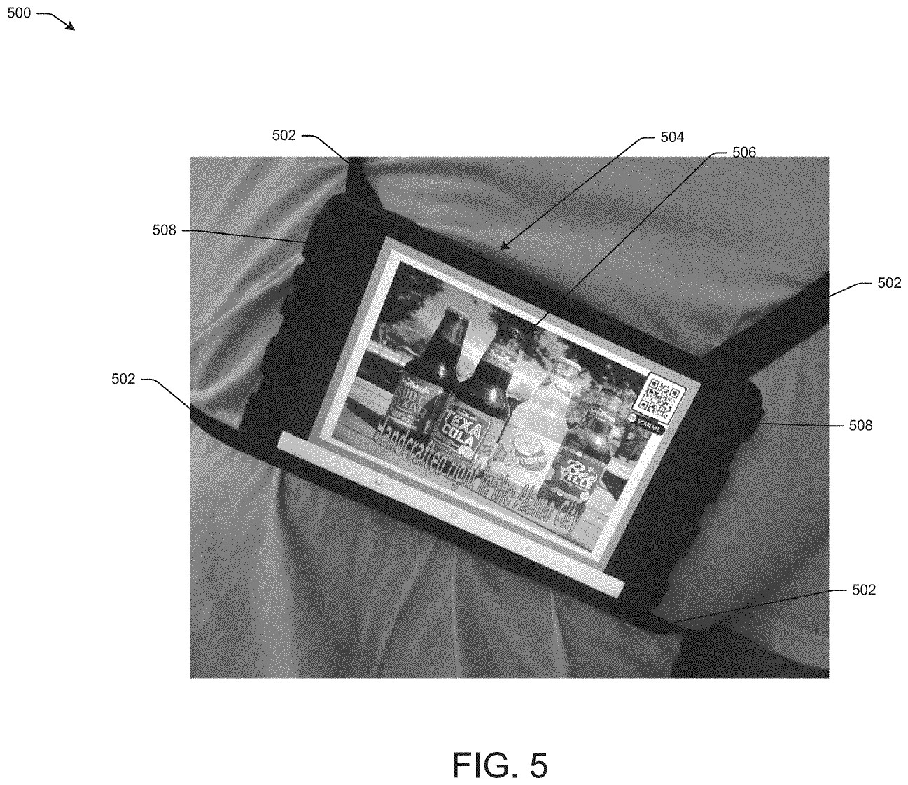

FIG. 5 illustrates an example wearable element 500, in accordance with one or more embodiments of the disclosure. The wearable element 500 may be another embodiment of a wearable element as described herein. The wearable element 500 may be similar to other embodiments described herein, include one or more straps 502 that may be used to secure the wearable element 500 to a user 501. The wearable element 500 may also be used to hold a mobile device 506. Rather than being held inside a compartment as illustrated in FIGS. 1, 2A, and 2B, the mobile device 506 may be secured to the wearable element 500 using one or more hook-and-loop fastener straps 508. The one or more hook-and-loop fastener strips 507 may be affixed to the mobile device 506. The one or more hook-and-loop fastener straps 508 attached to the wearable element 500 may be removably affixed to the one or more hook-and-loop fastener strips 507 on the mobile device 506. That is, the wearable element 500 may include a back portion, but may not include the partially or fully transparent front portion of some of the other embodiments described herein that may be used to fully enclosure the mobile device 506.

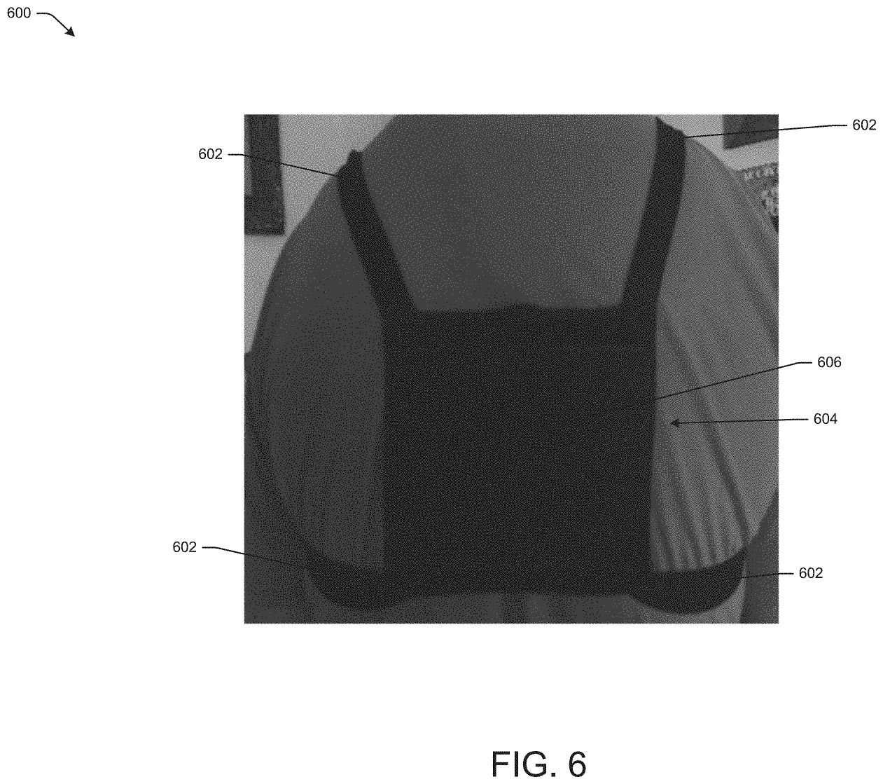

FIG. 6 illustrates an example wearable element 600, in accordance with one or more embodiments of the disclosure. The wearable element 600 may be another embodiment of a wearable element as described herein. The wearable element 600 may be similar to other embodiments described herein, include one or more straps 602 that may be used to secure the wearable element 600 to a user 601. The wearable element 600, like the wearable element 500, may not include one or more compartments as included in the wearable element 100 and wearable element 200 as described in FIGS. 1, 2A, and 2B. Similar to the wearable element 500, the wearable element 600 may be configured to allow a mobile device (not illustrated in the figure) to be directly removably affixed to the wearable element 600). The wearable element 600 may differ from the wearable element 500 in that the wearable element 600 may include hook-and-loop fastener on a front surface 606 rather than including hook-and-loop fastener straps as illustrated in FIG. 5. In this manner, if hook-and-loop fastener is attached to the back of the mobile device, the hook-and-loop fastener on the back of the mobile device may be removably affixed to the hook-and-loop fastener on the wearable element 600. This may allow the mobile device to be removably affixed to the wearable element 600.

It should be noted that while different embodiments of the wearable element are described herein, any of the aspects of each of the wearable elements may be included in any other embodiment. That is, aspects of certain wearable element embodiments may not necessarily be limited to only those embodiments. As one example, the second embodiment depicted in FIGS. 2A-2B may include the reflective material of FIG. 1.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that, individually and in combination, certain systems, and methods. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A mobile device holding apparatus comprising:
a back portion, wherein a section of the back portion includes a first material, and wherein the first material is configured to removably attach to a second material included on a back surface of a mobile device;
a first strap connected to the back portion at a first point and at a second point; and
a second strap connected to the back portion at a third point and at a fourth point.

2. The apparatus of claim 1, wherein the first material and the second material comprise a hook-and-loop fastener.

3. The apparatus of claim 1, further comprising a third strap and a fourth strap, wherein the third strap and the fourth strap include the first material.

4. The apparatus of claim 1, wherein the back portion includes a first top edge, a first bottom edge, a first left edge, and a first right edge, wherein the apparatus includes a front portion including a second top edge, a second bottom edge, a second left edge, and a second right edge, wherein at least one of the second top edge, the second bottom edge, the second left edge, and the second right edge are permanently or removably attached to the first top edge, the first bottom edge, the first left edge, and/or the first right edge, and wherein the front portion comprises a transparent material.

5. The apparatus of claim 4, wherein at least one of the second top edge, the second bottom edge, the second left edge, and the second right edge are removably attached to the first top edge, the first bottom edge, the first left edge, and/or the first right edge using the first material and the second material.

6. The apparatus of claim 4, wherein one or more openings exist between the back portion and the front portion when at least one of the second top edge, the second bottom edge, the second left edge, and the second right edge are permanently or removably attached to the first top edge using the first material and the second material.

7. The apparatus of claim 1, further comprising two or more physically separated compartments configured to receive one or more items.

8. The apparatus of claim 7, wherein a first compartment of the two or more physically separated compartments is included on a back-side of the back portion.

9. The apparatus of claim 1, further comprising a reflective material.

10. A mobile device holding apparatus comprising:
a front portion including a first top edge, a first bottom edge, a first left edge, and a first right edge. A back portion including a second top edge, a second bottom edge, a second left edge, and a second right edge, wherein at least one of the second top edge, the second bottom edge, the second left edge, and the second right edge are permanently or removably attached to the first top edge, the first bottom edge, the first left edge, and/or the first right edge, and wherein the back portion comprises a transparent material;
a first strap connected to the back portion at a first point and at a second point; and
a second strap connected to the back portion at a third point and at a fourth point.

11. The apparatus of claim 10, wherein a portion of the back portion includes a first material, and wherein the first material is configured to removably attach to a second material included on a mobile device.

12. The apparatus of claim 11, further comprising a third strap and a fourth strap, wherein the third strap and the fourth strap include the first material.

13. The apparatus of claim 12, wherein the first material and the second material comprise a hook-and-loop fastener.

14. The apparatus of claim 13, wherein at least one of the second top edge, the second bottom edge, the second left edge, and the second right edge are removably attached to the first top edge, the first bottom edge, the first left edge, and/or the first right edge using the first material and the second material.

15. The apparatus of claim 14, wherein one or more openings exist between the front portion and the back portion when at least one of the second top edge, the second bottom edge, the second left edge, and the second right edge are permanently or removably attached to the first top edge using the first material and the second material.

16. The apparatus of claim 10, further comprising two or more physically separated compartments configured to receive one or more items.

17. The apparatus of claim 16, wherein a first compartment of the two or more physically separated compartments is included on a back-side of the back portion.

18. The apparatus of claim 10, further comprising a reflective material.
